(19) United States
(12) Patent Application Publication
(10) Pub. No.: US 2011/0306905 A1
(43) Pub. Date: Dec. 15, 2011

(54) Shock wave apparatus with pneumatic drive

(76) Inventors: Pavel Novak, Stetten/SH (CH); Manfred Schulz, Tagerwilen/T (CH); Ernst H. Marlinghaus, Bottighofen/TG (CH); Georg Gömer, Landschlacht/TG (CH)

(21) Appl. No.: 13/158,212

(22) Filed: Jun. 10, 2011

(30) Foreign Application Priority Data
Jun. 11, 2010 (DE) DE202010007860.1

(51) Int. Cl. A61H 1/00

(52) U.S. Cl. 601/4

(57) ABSTRACT

According to the invention, the use properties of a shock wave apparatus are improved by providing a metrological detection of the pressing force in addition to a sensual perception of the pressing force by a user. In this context, the invention relates to a shock wave apparatus having a housing and a contact device held at the housing, wherein the contact device is held via a force sensor at the housing in such a way that a force is transmitted from the contact device to the housing via the force sensor, at least partially.

### FIELD OF THE INVENTION

The present invention relates to a shock wave apparatus for treating the human or animal body by mechanical shock waves.

### BACKGROUND OF THE INVENTION

Apparatuses for the treatment by mechanical shock waves are known, in particular in the field of lithotripsy. There, body concrements, for instance stones in the body tissue, are disintegrated by focused mechanical shock waves. Besides the generation by electrical discharges in water, apparatuses have been developed generating the mechanical shock waves by a collision of an accelerated projectile and an impact body. Such apparatuses are used in lithotripsy as well as in other treatments of biological body substances, wherein the treatment of muscle diseases and of diseases in the transition region between muscles and bones as well as applications in the field of dermatology are to be mentioned in particular.

### BRIEF SUMMARY OF THE INVENTION

The present invention has the object to provide a shock wave apparatus of the type described, which features improved use properties.

According to the invention, this problem is solved by a shock wave apparatus having a housing and a contact device held at the housing, for contacting the body, wherein the contact device is held via a force sensor at the housing in such a way that a force is transmitted from the contact device to the housing via the force sensor as an intermediate, at least partially.

The shock wave apparatus can be a combination of a hand held device and a basic unit supplying it, wherein the basic unit can be firmly installed or moveable, for instance portable or displaceable by casters, respectively. However, the term “shock wave apparatus” also refers to a hand-held device, which is for instance operated by battery and can be applied independently. In both cases, the pneumatic drive is implemented by a pressure gas, for instance air compressed by a compressor, wherein the expansion of the pressure gas can generate a shock wave directly or move mechanical components for its generation.

The basic idea of the invention is to provide, for the operation of the shock wave apparatus, a metrological detection of the pressing force in addition to a sensual perception of the pressing force by a user, for instance a physician or therapist. A measured value depending on the pressing force and determining the pressing pressure can be evaluated by a force sensor, which is, according to the invention, provided between the housing, via which the user applies the pressing force, and the contact device, which then contacts the body with a certain pressing pressure depending on the pressing force and a contact area. Detecting the pressing force in such an objectified manner is advantageous, because the pressing pressure determined by the pressing force has an influence on the coupling of the shock waves to the body, wherein the coupling is increasing with increasing pressing pressure. In case of a pressing pressure being too low, the intensity of the shock waves can for instance become too low in the body part to be treated for still achieving the intended physiological effect, whereas injuries, for instance skin injuries like hematoma for example, can result in case of a pressing pressure being too high.

Therein, the contact device is not necessarily connected to the housing via the force sensor only, but can for instance also be guided in a holding device of the housing in such a way that a relative displacement of the pressing device and the housing is basically only possible (or would be only possible neglecting the force sensor) along one axis. Therein, the direction of the relative displacement can for instance be chosen to basically coincide with a pressing direction, in which the shock wave apparatus is set on the body, and with a main propagation direction of the shock waves, which is a mean value or an average of a plurality of propagation directions. Then, a sensitive axis of the force sensor is preferably also arranged in this direction so that a force component being essential for the pressing pressure and the treatment, thus, is transmitted via the force sensor and provided thereby as a measured value to a user or to a control unit for the operation of the shock wave apparatus, respectively.

In detail, the holding of the contact device at the housing can be implemented in a plurality of ways. Depending on the specific holding device, the force transmission occurs not necessarily only via the force sensor, but can for instance also be transferred as an adhesive force between the contact device and the housing. Such an adhesive force being basically determined by static friction only can be independent of the pressing force in a first approach and can then, provided that an absolute value shall be outputted, for instance be corrected in the course of an offset-correction during a further processing of the measured value detected by the force sensor.

Preferred embodiments of the invention are provided in the dependent claims. In the following and in the whole disclosure, the description of the shock wave apparatus and of its use are not differentiated in detail, the disclosure referring to both categories, implicitly.

In one embodiment of the invention, the force sensor measures the force transmission piezoelectrically or in a piezoresistive manner. With piezoelectric sensors, a charge separation caused by a force-induced deformation of a piezoelectric material is evaluated for instance by a charging amplifier and is then provided as a measured quantity proportional to the force. Therein, piezoelectric sensors are particularly known for a good linearity and are further characterized by a robustness and an insensitivity against electromagnetic interference.

In the case of a piezoresistive pressure sensor, a force causes a deformation and, therewith, a change of the resistivity of a strain gauge due to its elongation or compression. The strain gauge can for instance be deposited as a metal, for instance on a silicon-containing material like silicon nitride, or can be generated by doping, for instance be diffused into silicon, wherein the substrate can also be provided, namely respectively thin as a membrane. Alternatively to a silicon substrate, a strain gauge can also be realized on a carrier made of a synthetic material, wherein a measuring grid being typically meander-like shaped can for instance be manufactured by coating and etching a metal foil correspondingly.

A piezoelectric or piezoresistive force measurement can then be realized by providing for example an elastically deformable element between the contact device and the housing, for instance an elastomer block. By measuring the deformation of the element under the influence of a force, for instance by a strain gauge, the force transmitted via the element can be evaluated if a corresponding material constant is known. To what extent a macroscopic relative displacement between the contact device and the housing occurs during the measurement also depends on the Young's modulus of the elastic element. Even though a sharp limit can not be provided here, a deformation of the element and a relative displacement, thus, are presently assumed in case of a Young's modulus significantly below 1 GPa. Therein, the deformation of the elastic element can for instance be measured in the direction of the relative displacement or also transversally thereto so that, in the latter case, for instance an expansion occurring transversally to a compression in the direction of the relative displacement is evaluated, namely a displacement of the elastic element.

Also, a fluid cushion can be provided as a coupling member between the contact device and the housing, wherein the force measurement can for instance occur by evaluating a change of the pressure in the fluid, then. The fluid cushion itself will deform more or less in response to the applied force depending on its shape, on the deformation properties of a shell surrounding the fluid, or on the viscosity of the fluid itself, namely can be adapted for a measurement at a relative displacement between the contact device and the housing or basically without any relative displacement.

In a further embodiment, the force measurement is implemented without a displacement, namely basically without a relative displacement between the contact device and the housing. In this respect, for example a piezoelectric sensor made for instance of a piezoelectric ceramic or a monocrystalline material responds to a force without a deformation, basically. Then, if the force transmission occurs directly via the sensor, its marginal deformation defines the relative displacement so that the force is measured without a relative displacement between the contact device and the housing, basically. In consequence, sensually, a user perceives no difference in handling the shock wave apparatus in comparison to the apparatuses he is familiar with.

This also applies in case of a piezoresistive measurement by either a strain gauge, whose membrane having a high Young's modulus directly transmits the force, or a strain gauge on the basis of a synthetic material carrier, being provided on a coupling member having a correspondingly high Young's modulus, for instance on a block of metal.

Even though a relative displacement in a range of micrometers and below can occur, in case of a direct force transmission via a piezoelectric sensor as well as in case of the options just mentioned for a piezoresistive measurement, such a relative displacement of, in this order increasingly preferred, less than 50 μm, 30 μm, 10 μm, 1 μm is described as “no relative displacement” in this disclosure and the measurement as “without a displacement”.

In another embodiment, the force sensor measures a relative displacement between the contact device and the housing optically, electrically, electromagnetically, or magnetically. In this embodiment, the pressing force causes a relative displacement, thus, which can be measured optically, for instance by a laser-based distance measurement, or electrically, for instance by a capacitive distance measurement. Further, the measurement can also be performed electromagnetically, for instance by an induction in a coil caused by the field of a further coil fed with an alternating current, or also magnetically, for instance by a Hall sensor in combination with a permanent magnet.

Therein, by implementing the relative displacement with an elastically deformable holding, a corresponding value of the force results when knowing a Young's modulus of the holding, typically significantly below 1 GPa. Such an elastic holding can for instance be implemented by an elastically deformable element between the housing and the contact device, for instance an elastomer body or an elastomer ring, in particular an O-ring. Further, an aforementioned fluid cushion adapted to be correspondingly deformable, namely allowing a relative displacement, can be provided.

In a further embodiment, the relative displacement between the contact device and the housing is subjected to a force by a spring member. Therein, the spring member deforms in response to the application of a force, possibly in a preferred direction, and returns into the initial state after releasing the force, provided that the value of the force does not exceed a certain limit. For instance a coil spring, in particular a helical compression spring, can be provided as such spring member between the contact device and the housing and can be arranged with its coil axis basically parallely to the pressing direction, then. The relative displacement of a contact device, which is for instance shiftably held at the housing in the above described manner, is subjected to a force by the helical compression spring, then, wherein the force is preferably directly proportional to the relative displacement, at least within a certain region. Therein, the shiftability of the contact device away from the housing can be limited by a stop, which can optionally already compress the helical compression spring partially and hold the contact device in position, thus, even though it is not pressed against the body. The coil spring can for instance be made of a synthetic material or of a metallic material, for instance be coiled of a wire.

Due to the spring-loaded relative displacement between the contact device and the housing, the rise of the contact pressure when applying the shock wave apparatus is in particular not only determined by the consistency of the body part to be treated, but rises with a delay corresponding the relative displacement, even in case of a body region showing less deformation, for instance. Thereby, a certain “gearing” between a pressing-on-movement and the pressing pressure is provided to the user, wherein the gearing ratio is increasing with a decreasing spring constant so that the pressing pressure can be adjusted more precisely and the objectified capturing of the force sensor can be applied in a particularly advantageous manner.

According to a further embodiment, the generation of a shock wave is released or triggered, when a value evaluated by the force sensor exceeds a minimum value. This feature is advantageous for the user, because he either can trigger the shock wave only after reaching the respective minimum value or even no longer has to trigger the generation of the shock wave himself. As far as the shock wave triggering shall occur at a certain pressing pressure, not only one handling operation can be omitted, but also an otherwise complex eye-hand coordination be facilitated. Further on, this feature easily enables a treatment with repeatedly triggered shock waves at an almost identical pressing pressure, whereby the effectiveness of the treatment is increased and possible injuries resulting from a pressing pressure being too high can better be avoided. Therein, in preferred embodiments, a corresponding minimum value can particularly also be adjustable and be for instance adapted to a specific objective of the treatment.

In a further embodiment, triggering the shock wave generation is blocked, when a value detected by the force sensor exceeds a maximum value. Thus, in this embodiment, a safety mechanism is provided, which blocks the shock wave generation, when the coupling of the shock wave into the body would cause an undesirably high intensity of the shock wave treatment or a skin irritation due to a pressing force of the shock wave apparatus being too high. Therein, in particular, the maximum value can also be adjustable and can for instance be reduced when treating sensitive body regions.

In a further embodiment of the shock wave apparatus, a value detected by the force sensor is readable on an optical display. Therein, an analog or digital signal can be fed to the optical display, which signal can previously be processed in an evaluation unit, if necessary, namely can for instance be digitized or amplified and in particular also adjusted with respect to an offset. Then, for instance a value basically corresponding to the pressing force or to the pressing pressure, namely the pressing force normalized by the contact area, or also a dimensionless value can be provided to the user.

The optical display can display the value for instance by digital numbers or a pointer with a corresponding scale and be provided only at the hand held device or, in case of a shock wave apparatus with a supplying basic unit, also at the basic unit, solely or in addition.

Due to the optical display, a user can more easily apply the pressing force required for an optimal shock wave coupling, depending for instance on the specific purpose of the treatment or the body part to be treated. Further, the pressing force can also be kept constant during the treatment more easily or can systematically be altered. Therein, the optical display can be provided in addition to a control unit automatically triggering shock waves or blocking or releasing the generation thereof, however, otherwise, the optical display is also on its own an implementation of the idea of the invention by providing information to a user for operating the shock wave apparatus.

In a further embodiment, an acoustic signal generator is provided, which is adapted for outputting an acoustic signal at a certain value detected by the force sensor.

Here, also several acoustic signals differing from each other can be provided so that for instance a first signal tone indicates reaching a desired pressing pressure and an alert indicates exceeding a critical pressing pressure. Further, it is possible to indicate a change of the pressing pressure by a change of the volume so that for instance an increase of the volume with increasing pressing pressure can enable an intuitive handling. Here, again, any combinations with the automatic operation and also with the optical display are possible.

In a further embodiment, the shock wave apparatus is adapted for a force measurement by the force sensor after the generation of the shock wave, which detects a characteristic of the response of the body to the coupling of the shock wave. If for instance the stiffness of tissue or muscles changes due to the shock wave treatment, such a change can then be captured by a force measurement subsequent to the shock wave generation, because the change of the stiffness causes a change of the vibration properties of the body part treated, which can be captured by the sensor. Measuring for instance the characteristic frequency of the body part or body region treated can monitor a decrease or increase of its stiffness. Since the force measurement for evaluating the response characteristic of the body is performed by the same force sensor measuring also the pressing pressure, a combination of both measurements is possible in a particularly easy and economically advantageous manner.

Therein, in a further embodiment, a value of the force measurement can be fed to a control unit, which control unit is adapted for applying the value as a control variable for an adjustment of a subsequent shock wave so that the adjustment is adapted to the response characteristic of the body. The response characteristic of the body can for instance be characterized by the stiffness of the tissue or muscles or by a movability of individual body parts or bones. Depending on the specific objective of the treatment, a corresponding value is for instance evaluated for a period of several shock waves so that the intensity of the shock waves can for instance be increased, when no change occurs. Otherwise, the intensity can for instance also be lowered or the treatment stopped completely, when a corresponding value remains basically unchanged after a period of changes.

The invention also relates to a shock wave apparatus having a pressing device being adapted as a part of the housing for pressing a body part to be treated against the contact device. Thus, in addition to pressing the shock wave apparatus, the body part to be treated can also be pressed against the shock wave apparatus by a mechanical pressing device provided for that purpose. Since the pressing device is a part of the housing, therein, the force component relevant for the pressing pressure is transmitted from the contact device to the housing and thus via the force sensor. As far as a movement of the shock wave apparatus towards the body part is described in the context of this disclosure, the described functionality shall also be disclosed for a movement of the body part towards the shock wave apparatus.

In a further embodiment, the shock wave apparatus comprises a projectile, which is moveable by a pneumatic drive and is adapted for an impact to generate the shock wave. The projectile can for instance be guided in a linear guiding device and be accelerated in the guiding device by an expansion of a pressure gas. However, the pneumatic drive can for instance also drive a rotary motion of an axis, to which the projectile is connected and is moved on a circular path, thus. For generating the shock wave, the projectile can directly collide against the body or also against a further device.

In a further embodiment, such a further device is an impact body for generating the shock wave as a result of a pressure pulse of the pneumatic drive. Therein, on the one hand, a shock wave can be generated by a collision of a projectile with the impact body in the manner just described or, otherwise, can also solely be generated by the interaction of a pressure pulse, which is the expansion of the pressure gas, with the impact body, for instance if the impact body is moved by a pressure pulse out of its rest position.

In a further embodiment, a guiding tube is provided for guiding such a pressure pulse of the pneumatic drive, wherein, further preferred, a projectile is moveable in the guiding tube by a pressure pulse to generate the shock wave by colliding with the impact body at the end of a movement through the guiding tube.

In one embodiment of the invention, “contact device” represents the impact body so that the force transmission from the impact body to the housing occurs via the force sensor, at least partially. Thus, as far as a guiding tube is provided in this embodiment, it is a part of the housing and is, in the context of usual mounting techniques, firmly connected thereto.

In another embodiment, however, the guiding tube is the contact device held at the housing so that the force transmission from the guiding tube to the housing occurs via the force sensor, at least partially. As far as an impact body is provided in this embodiment, it constitutes the contact device together with the guiding tube and is that part thereof, which contacts the body during operation. Therein, in particular, the impact body can be held elastically at the guiding tube, for instance by elastomer rings as for example O-rings.

The invention also relates to a use of the shock wave apparatus for pressing it against a human or animal body and measuring a pressing force. Namely, a shock wave apparatus according to the invention can for instance be set on a respective body region and be pressed against it with increasing force for an objectification of the sensation of pain or for locating trigger points, wherein measuring the pressing pressure by the force sensor allows a reproducible quantification of the local pressing induced pain threshold (F meter function). Such a use can also occur independent of the shock wave treatment so that two fields of application are advantageously provided to the user with only one apparatus. However, by combining the F meter function with a shock wave treatment, the locations relevant for a treatment can also be identified prior to the treatment or the result of a treatment can be checked thereafter.

In the following, the invention is explained in further detail by means of exemplary embodiments, wherein the individual features can also be relevant for the invention in other combinations and relate to all categories of the invention, implicitly.

### BRIEF DESCRIPTION OF THE DRAWINGS

FIG. 1 shows a shock wave apparatus with a spring-loaded relative displacement of the guiding tube and the housing.

FIG. 2 shows a piezoresistive force measurement between the guiding tube and the housing.

FIG. 3 shows a spring-loaded relative displacement of the impact body and the guiding tube.

### DETAILED DESCRIPTION OF THE INVENTION

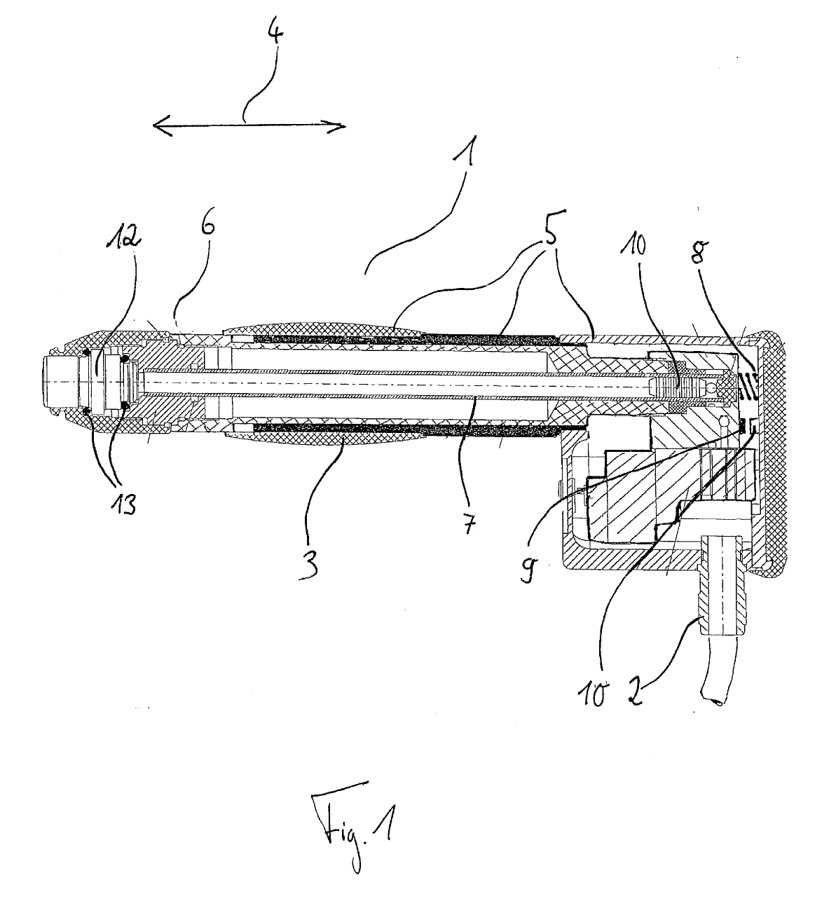

FIG. 1 shows a hand piece of a shock wave apparatus 1 for treating the human or animal body by mechanical shock waves, which is supplied with pressure gas via a supply connection 2 by a basic unit (not shown) equipped with a compressor. The hand-held device can be gripped at the handle surface 3, for instance by a physician treating, and can be set on the body with its left end and pressed against it in the direction 4. Together with further components fixed in their relative position when assembled, the handle surface 3 constitutes the housing 5. A contact device 6 is held in a shaft of the housing 5 in such a way that a relative displacement between the contact device 6 and the housing 5 is possible along the axis 4. A guiding tube 7 is held in the contact device 6 and is arranged axially and concentrically, therein. The relative displacement between the housing 5 and the contact device 6 with the guiding tube 7 is subjected to a force by the spring member 8 so that a force increasing with the distance covered is required for pushing the guiding tube 7 towards the housing 5, namely to the right in the figure. By measuring the distance with a permanent magnet 9 and a hall sensor 10, the relative displacement between the contact device 6 and the housing 5 can be evaluated. Therefrom, a corresponding force value can then be taken, namely in dependence of the spring constant and taking a precompression into account.

The relative displacement between the guiding tube 7 and the housing 5, occurring when setting the left end (in this figure) of the shock wave apparatus 1 on and pressing it along the axis 4, provides a force value, thus, which basically corresponds the pressing force. The spring 8 is compressed between the contact device 6 and the housing 5 by the force applied by a user and causes a corresponding counterforce in turn, by which the contact device 6 is pressed on. However, due to frictional forces in the holding between the housing 5 and the guiding tube 7, the force applied by a user is not necessarily only transmitted via the spring 8 to the contact device 6. A projectile 11 is guided in the guiding tube 7, which can be accelerated by a pressure pulse of the pressure gas along the axis 4 to the left, wherein this movement is limited by the impact body 12. Thus, the projectile 11 is accelerated from a proximal (right) to a distal (left) end of the guiding tube 7 and generates a shock wave by colliding with a proximal end of the impact body, then, which shock wave is coupled into the body via the distal end of the impact body 12. The impact body 12 is elastically held with respect to the contact device 6 by two O-rings 13.

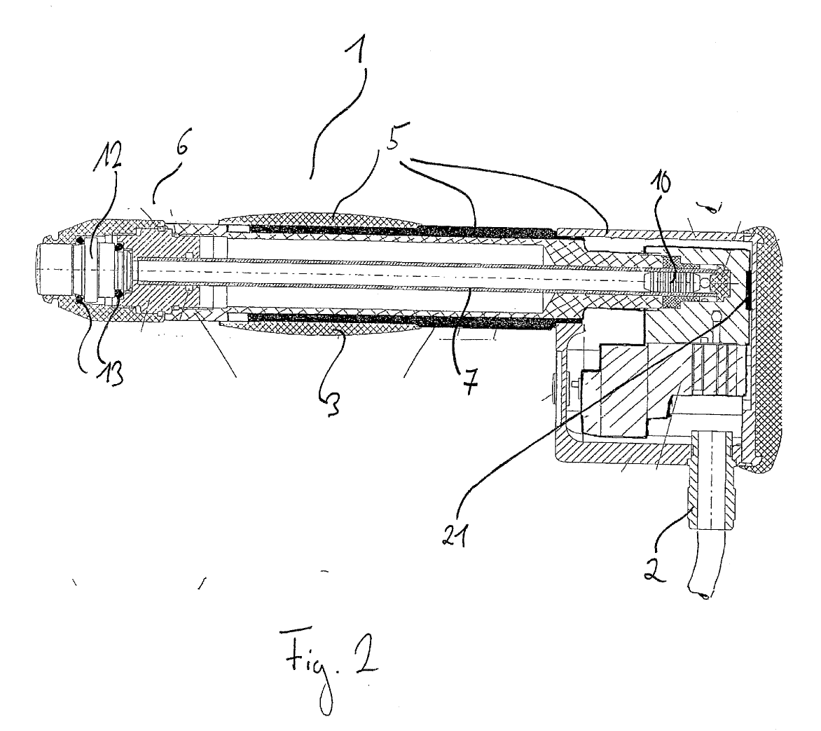

As regards the shock wave apparatus shown in FIG. 2, parts having an identical function as in FIG. 1 are referenced by the same reference numerals. Again, the impact body 12 constitutes the contact device 6 together with the guiding tube 7, wherein the contact device 6 is held at the housing. Therein, as in FIG. 1, the contact device 6 is guided in an axial shaft of the housing, wherein no further force transmitting connection is provided between the shaft and the contact device 6 so that the adhesive force is dominant, basically. However, in contrast to FIG. 1, no relative displacement of the contact device 6 towards the housing 5 is possible in this exemplary embodiment, because no spring member 8 is provided between the contact device 6 and the housing 5, but a piezoresistive sensor 21 instead.

The piezoresistive sensor 21 measures a change of pressure by measuring a change of the electric resistance of the piezoresistive material, which corresponds, depending on the sensor area, to a force applied. Here, even though the piezoresistive material is deformed, this deformation is in the order of micrometers so that basically no relative displacement occurs between the contact device 6 and the housing 5 from a macroscopic point of view.

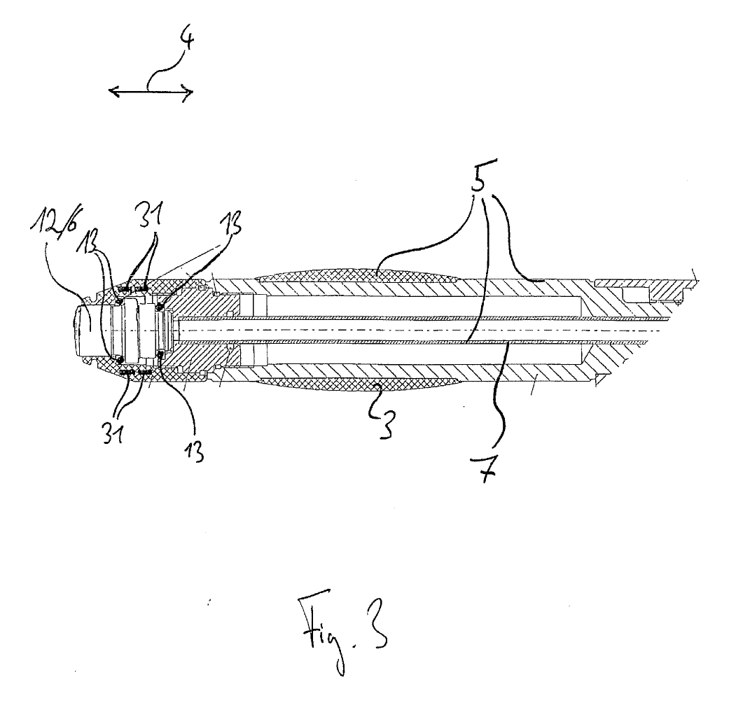

FIG. 3 shows the guiding tube 6 and the impact body 12 of a shock wave apparatus 1, which generates shock waves by the collision of a projectile 11 against the impact body 12 as described in the context of FIG. 1. However, in this case, the guiding tube 7 is not moveably held at the housing, but is, as a part of the housing 5, fixed in its position relative thereto. In this case, the contact device held at the housing 5 is the impact body 12, which is moveably held with respect to the housing by the elastomer rings 13. When pressing the shock wave apparatus 1 against the body, the impact body 12 is shifted towards the housing 5, wherein this shifting is measured by two differential coils 31. During this shifting, the proximal one of the two elastomer rings 13 is compressed, wherein the compression is proportional to the force acting, which can then be derived from the displacement and a Young' s modulus of the O-rings 13.

In this embodiment, a pressing device can be provided at the guiding tube 7 for encompassing the body part to be treated and pressing it towards the impact body 12. Since the force is measured between the pressing device and the contact device, therein, a value relevant for the pressing pressure is detected.

In comparison to the embodiments shown in FIGS. 1 and 2, the Young's modulus of the O-rings 13 can be chosen smaller to enable a relative displacement, which can be measured easily. On the other hand, as far as a considerable relative displacement occurs also in FIGS. 1 and 2, this relative displacement can for instance be considered in an evaluation and the measured force value can be corrected correspondingly.

What is claimed is:

1. A shock wave apparatus for treating the human or animal body,
having a pneumatic drive for generating a shock wave,
having a housing and a contact device for contacting said body,
wherein said contact device is held at said housing,
characterized in that
said contact device is held at said housing via a force sensor in such a way that a force is transmitted from said contact device to said housing via said force sensor, at least partially.

2. The shock wave apparatus according to claim 1, wherein said force sensor measures said force transmission piezoelectrically or in a piezoresistive manner.

3. The shock wave apparatus according to claim 1, wherein a force measurement occurs without a displacement.

4. The shock wave apparatus according to claim 1, wherein said force sensor measures a relative displacement of said contact device and said housing optically, electrically, electromagnetically, or magnetically.

5. The shock wave apparatus according to claim 4, wherein said relative displacement of said contact device and said housing is additionally subjected to a force by a spring member.

6. The shock wave apparatus according to claim 1, wherein a generation of a shock wave is released or triggered, if a value detected by said force sensor exceeds a minimum value.

7. The shock wave apparatus according to claim 1, wherein triggering a shock wave is blocked, when a value detected by said force sensor exceeds a maximum value.

8. The shock wave apparatus according to claim 1, wherein a value detected by said force sensor is readable on an optical display.

9. The shock wave apparatus according to claim 1 having an acoustic signal generator, which is adapted for outputting an acoustic signal at a certain value detected by said force sensor.

10. The shock wave apparatus according to claim 1, which is adapted to a force measurement by said force sensor after said generation of said shock wave, which force measurement detects a response characteristic of said body to said coupling of said shock wave.

11. The shock wave apparatus according to claim 10, wherein a value of said force measurement can be fed to a control unit, which control unit is adapted for using said value as a control variable for an adjustment of a subsequent shock wave so that said adjustment is adapted to said response characteristic of said body.

12. The shock wave apparatus according to claim 1, wherein a pressing device is adapted as a part of said housing for pressing a body part to be treated against said contact device.

13. The shock wave apparatus according to claim 1 having a projectile, which is moveable by said pneumatic drive and is adapted for an impact to generate said shock wave.

14. The shock wave apparatus according to claim 1 having an impact body for a generation of said shock wave as a result of a pressure pulse of said pneumatic drive.

15. The shock wave apparatus according to claim 1 having a guiding tube, which is adapted for guiding a pressure pulse of said pneumatic drive.

16. The shock wave apparatus according to claim 15, wherein a projectile is moveable in said guiding tube to generate said shock wave by colliding with an impact body at the end of a movement through said guiding tube.

17. The shock wave apparatus according to claim 16, wherein said impact body is said contact device held at said housing so that a force is transmitted from said impact body to said housing via said force sensor, at least partially.

18. The shock wave apparatus according to claim 16, wherein said guiding tube is said contact device held at said housing so that a force is transmitted from said guiding tube to said housing via said force sensor, at least partially.

19. A method for measuring a pressing force comprising pressing the shock wave apparatus according to claim 1 against a human or animal body and obtaining a measurement of a pressing force.

20. The method of claim 19, wherein said measurement of a pressing force is used for least one of an objectification of pain and locating trigger points.
